(19) United States
(12) Patent Application Publication
(10) Pub. No.: US 2021/0293321 A1
(43) Pub. Date: Sep. 23, 2021

(54) TRANSMISSION HOUSING ASSEMBLY WITH A FREEWHEEL FOR SUPPORTING A MOTOR SHAFT

(71) Applicant: Nidec Corporation, Kyoto (JP)

(72) Inventors: Pascual GUARDIOLA, Ingersheim (DE); Uwe LASEBNICK, Stuttgart (DE)

(21) Appl. No.: 17/192,938

(22) Filed: Mar. 5, 2021

(30) Foreign Application Priority Data
Mar. 19, 2020 (DE) 102020107597.9

(51) Int. Cl. F16H 57/021; F16H 61/32

(52) U.S. Cl. CPC F16H 57/021; F16H 2057/02034; F16H 61/32

(57) ABSTRACT

A transmission housing assembly includes a transmission housing and a freewheel including an inner ring and an outer ring. The inner ring is non-positively connectable to a motor shaft, and a steel bearing bush is inserted into an opening of the transmission housing, into which the freewheel is pressed in order to press-fit the outer ring with the steel bearing bush and the transmission housing.

### CROSS REFERENCE TO RELATED APPLICATION

The present invention claims priority under 35 U.S.C. § 119 to German Application No. 102020107597.9 filed on Mar. 19, 2020, the entire contents of which are hereby incorporated herein by reference.

### FIELD OF THE INVENTION

The present invention relates to a transmission housing assembly with a freewheel to support a motor shaft, in particular for an automatic transmission of a motor vehicle, as well as an actuator of a motor vehicle automatic transmission.

### BACKGROUND

It is well known to mount motor shafts in a freewheel to protect the motor from damage. If the motor is followed by a transmission, the freewheel can be used in the transmission housing. The freewheel is pressed into the transmission housing. However, this press fit does not provide a reliable fit over a wide temperature range.

### SUMMARY

Example embodiments of the present disclosure provide transmission housing assemblies each including a freewheel to support a motor shaft, which provides a safe and cost-effective connection between transmission housing and freewheel.

A transmission housing assembly according to an example embodiment of the present disclosure includes a transmission housing and a freewheel including an inner ring and an outer ring. The inner ring is non-positively connectable to a motor shaft and a steel bearing bush is inserted into an opening in the transmission housing. The freewheel is pressed into the opening in order to connect the outer ring to the steel bearing bush and the transmission housing. The steel bearing bushing is preferably inserted in the housing with a clearance fit. It is advantageous to include an anti-rotation device so that the housing is connected to the steel bearing bushing in a manner that prevents rotation.

The use of a steel bearing bushing ensures that the freewheel is firmly seated in the transmission housing over a wide temperature range and that the forces generated by reverse rotation of the motor shaft can be absorbed. The freewheel is preferably a ball bearing freewheel.

Preferably, the opening of the transmission housing is located centrally in the transmission housing.

The steel bearing bushing includes protruding projections at one end in the radial direction, the protruding projections are connected to an upper side of the transmission housing to prevent rotation.

It is preferable that the freewheel includes a backstop and allows rotation of the motor shaft only in one direction, for example, a forward rotation direction of the electric motor.

An actuator of a vehicle automatic transmission may include an electric motor with a motor shaft and a transmission with a previously described transmission housing assembly.

An example embodiment of the present disclosure is explained in more detail below on the basis of the drawing.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 shows a transmission housing of a transmission housing assembly according to an example embodiment of the present disclosure.

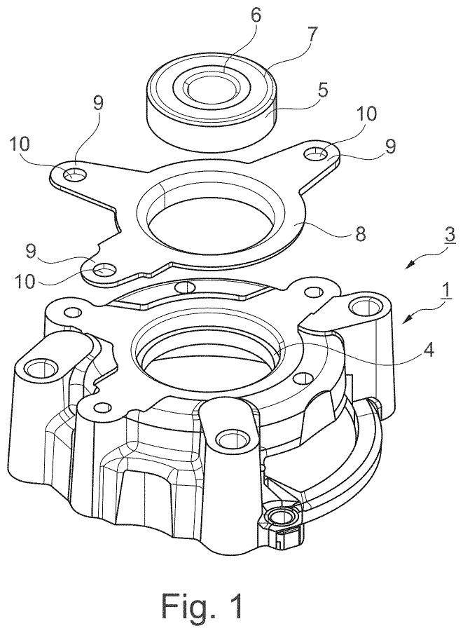

### DETAILED DESCRIPTION

The transmission housing 1 has a central opening 4 into which a freewheel 5 is inserted. The freewheel 5 is a ball bearing freewheel with inner ring 6 and outer ring 7. The ball bearing freewheel 5 is used as a backstop, i.e. it prevents the motor shaft not shown from rotating backwards.

The outer ring 7 has not shown recesses on the inside, in which balls are accommodated. The balls are spring preloaded towards a clamping position. The recesses extend in the circumferential direction, with the depth of the recess decreasing continuously in the opposite direction to the direction of forward rotation of the motor. In the clamping position, the depth is so small that the balls are clamped between the inner ring 6 and the outer ring 7 so that rotation of the motor shaft in the reverse direction is prevented. If the inner ring 6 rotates with the motor shaft in the forward direction of rotation of the motor, the balls are pressed against the spring force into an area of the recess where the balls have no contact with both rings 6,7. In this freewheel area, the motor shaft can rotate freely without blocking.

The described ball bearing freewheel 5 is only one of many suitable freewheels with backstop available on the market. Also available are freewheels without springs, with cylindrical rollers instead of balls and/or freewheels with sprags. Depending on the application, an appropriate freewheel must be selected.

Transmission housing 1 is made of aluminum and is manufactured by die-casting aluminum. However, due to the high coefficient of thermal expansion, the aluminum housing is not suitable for a secure and tight fit of the freewheel 5 in the opening 4 and for good support of the occurring forces at high temperatures. A steel bearing bush 8 is therefore fitted in the opening 4, into which the freewheel 5 is pressed. The steel bearing bushing 8 holds the freewheel 5 securely in position over a temperature range of −40° C. to 150° C. with constant force absorption. During assembly, the steel bearing bushing 8 is inserted into the opening 4 of the transmission housing with clearance fit and press-fitted with the freewheel 5. The freewheel is preferably made of hardened steel. The outer ring 7 of the freewheel 5 is thus in contact with the steel bearing bushing 8 on the outside. The inner ring 6 of the freewheel 5 is press-fitted with the motor shaft not shown. The steel bearing bushing 8 has protruding projections 9 in radial direction, which have drilled holes 10 at their ends. The drill holes 10 are used to receive screws that fix the bearing assembly with the transmission housing 1 in the axial direction by screwing them to the top of the transmission housing 1 and provide an anti-rotation lock.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A transmission housing assembly, comprising:
a transmission housing; and
a freewheel including an inner ring and an outer ring; wherein
the inner ring is non-positively connectable to a motor shaft;
a steel bearing bush is in an opening of the transmission housing; and
the freewheel is pressed into the opening to connect the outer ring with the steel bearing bush and the transmission housing.

2. The transmission housing assembly according to claim 1, wherein the opening of the transmission housing is centrally located in the transmission housing.

3. The transmission housing assembly according to claim 1, wherein the steel bearing bushing includes radially projecting projections connected to an upper side of the transmission housing to provide an anti-rotation device at one end of the steel bearing bushing.

4. The transmission housing assembly according to claim 1, wherein the transmission housing assembly includes a motor shaft and the inner ring is seated on and is pressed to the motor shaft.

5. The transmission housing assembly according to claim 1, wherein the freewheel includes a backstop and allows rotation of the motor shaft in only one direction.

6. The transmission housing assembly according to claim 1, wherein the steel bearing bush is inserted with a clearance fit into the opening of the transmission housing.

7. An actuator of an automotive automatic transmission, the actuator comprising:
an electric motor with a motor shaft; and
a transmission with a transmission housing assembly according to claim 1.
